(19) United States
(12) Patent Application Publication
(10) Pub. No.: US 2008/0201447 A1
(43) Pub. Date: Aug. 21, 2008

(54) Online social networking method based on third party's evaluation and system therefor

(76) Inventor: Young Wook Kim, Seoul (KR)

Correspondence Address: HESLIN ROTHENBERG FARLEY & MESITI PC, 5 COLUMBIA CIRCLE, ALBANY, NY, 12203, US

(21) Appl. No.: 11/690,948

(22) Filed: Mar. 26, 2007

(30) Foreign Application Priority Data
Feb. 15, 2007 (KR) 10-2007-0015965

(51) Int. Cl. G06F 15/16

(52) U.S. Cl. 709/218

(57) ABSTRACT

An on-line social networking method is presented based on a third party's evaluation, wherein third party's opinions are taken into consideration in constructing a community or building a network using the Internet. A network for only those users who can trust one another is guaranteed, and thus network quality is enhanced and a variety of incidents prevalent in the Internet are prevented. For this purpose, a server of an Internet website is employed in providing a social networking module, a first member terminal group for requesting a friend relationship, a second member terminal group for determining whether to approve the friend relationship, and a third member terminal group for generating evaluation information on an evaluation target member. The third member terminal group is an advisor group of the second member terminal group.

### CROSS-REFERENCE TO RELATED APPLICATION

This application claims priority to Korean Patent Application No. 10-2007-0015965, filed Feb. 15, 2007, which is hereby incorporated herein by reference in its entirety.

### TECHNICAL FIELD

The present invention relates to a method of social networking using the Internet. More specifically, the present invention relates to a method for enhancing networking quality by mitigating problems that arise from online human networking.

### BACKGROUND OF THE INVENTION

The Internet is a pervasive communication means. A vast amount of information is circulated through the Internet, and a large number of people are connected to and interact with one another through the Internet. In the past, the Internet has been emphasized as a means for simply searching for and providing information. However, the Internet plays an important role in every human behavioral domain, such as politics, society, culture, shopping, amusement, and the like, and is recognized as a vast new world. In this new world, freedom of communication is guaranteed, segregations and boundaries are abolished, and particularly laid down rules or distance limits are nonexistence. The new world is also a huge borderless society in which everything seems to be within possibility. Accordingly, a lot of people meet, interact, make friends, and organize communities without restrictions in an online space. As a result, leaving out of conventional offline networking, people come to understand other people's likings, interests, backgrounds, occupations, and the like through the online space and participate in social networking.

The online social networking is accomplished in a variety of ways. Personal information is exchanged with one another through an Internet homepage, blog, Internet café (community), and the like, and people exchange opinions and information or chat with other people by means of emails, web bulletin boards, web memoranda, reply notes, chatting, and the like. On the other hand, a membership system maintained through a membership join and authentication process has put the online social networking in order to some extent.

Here, it needs to define “friend” as a terminology that is frequently used in an online space. “Friend” is defined as social networking made in the online space or a symbol representing the social networking. For example, if a certain member (hereinafter, referred to as a “member A”) makes friends with another member (hereinafter, referred to as a “member B”), it means that member A and member B belong to a certain same community. Member A and member B who belong to the same community of “Friend” show further more interests to each other and receive a benefit of exchanging further more information compared with a third party. Types of setting a “friend” are categorized as shown in the following table.

| | |
|---|---|
| Type 1 | Member A sets member B as a friend at his or her own will |
| Type 2 | Requested from member A, member B sets member A as a |
| | friend at his or her will |
| Type 3 | Members A and B set friends to each other at their wills |

FIG. 1 a view showing an example of conventional social networking. Member A can set member B as a “friend” at his or her will. This is one-way relationship setting for giving a special benefit to member B as a “friend”, from which mature social networking cannot be expected since member B's intention is not respected at all. Contrarily, member B's intention is respected in FIG. 2. Member A requests member B to make friends through an email, a web note, or the like, and member B accepts member A's request at member B's own will, thereby establishing a “friend” relationship. Internet communities mainly use this method. However, there is a problem in that member B does not have any reference for determining whether making friends with member A is beneficial or not.

On the other hand, FIG. 3 is a view showing an example in which both member A and member B set each other as a friend. In this case, further advanced networking can be expected. However, the problem described in the example of FIG. 2 still remains.

### SUMMARY OF THE INVENTION

The aforementioned online-based social networking exposes a common problem which may have a fatal impact on human networking. Social networking made offline is a system that can be verified to some extent by directly meeting each other, or through other human networks. In offline social networking, since people can directly meet other people face to face or obtain information from a third party meeting in the face, it is advantageous in that character, good and bad points, sincerity, social status, and the like of a person can be verified. Contrarily, since online networking guarantees anonymity and is weak in verifying people to one another, there is a problem in that incidents, such as a lie, fraud, distrust, slander, personal information leakage, defamation, and the like, frequently happen.

An object of the present invention therefore is to solve the problems of conventional human networking made online and to implement advantages of offline networking in an online space.

Accordingly, the present invention is intended to apply advantages of offline networking, i.e., listening to and integrating third parties' opinions, to online networking in building online social networking.

The present invention has been made in an effort to solve the above problems, and it is an object of the present invention to take third party's opinions into consideration in constructing a community or building a network using the Internet, through which further objective information can be collected among users who make the networking.

Another object of the present invention is to guarantee a network for only those users who can trust in one another, thereby enhancing network quality and preventing a variety of incidents prevailed in the Internet.

Yet another object of the present invention is to enhance stability of human relation that builds the aforementioned network, thereby developing online-based social networking itself one step further.

On the other hand, still another unspecified objects of the present invention will be additionally considered within the range that can be easily inferred from the detailed descriptions and effects thereof described below.

In other to achieve the above objects, an on-line social networking method based on third party's evaluation, where terminals are connected to one another through the Internet, the method comprising the steps of: allowing a certain member (member A) terminal to transmit a friend relationship registration request signal to another member (member B) terminal; allowing the member B terminal to transmit an evaluation request signal for evaluating the member A to one or more terminals belonging to an advisor group; allowing a terminal of the advisor group that receives the evaluation request signal to generate evaluation information on the member A; allowing the member B terminal to monitor the evaluation information in real-time; allowing the member B terminal to transmit a response signal notifying whether to accept the friend relationship registration to the member A terminal; and if the response signal is “Yes”, registering a fact that the member A and the member B have a friend relationship with each other.

And, the advisor group may be a member group (A₁, A₂, A₃, . . . , and Aₙ, n is an integer not smaller than 1) having a friend relationship with the member A.

And, the advisor group may be a member group (B₁, B₂, B₃, . . . , and Bₙ, n is an integer not smaller than 1) having a friend relationship with the member B.

And, the advisor group may be a member group (C₁, C₂, C₃, . . . , and Cₙ, n is an integer not smaller than 1) having a friend relationship with both the member A and the member B.

And, the advisor group can includes a first group (B₁, B₂, B₃, . . . , and Bₙ, n is an integer not smaller than 1) having a friend relationship with the member B and a second group (C₁, C₂, C₃, . . . , and Cₙ, n is an integer not smaller than 1) having a friend relationship with both the member A and the member B.

And, the members may be members of a same website that provides a social networking module.

And, the method further can comprise the step of: allowing the member A terminal to monitor the evaluation information in real-time.

And, the evaluation information can includes \textcircled{1} “Approval”, \textcircled{2} “Disapproval”, and \textcircled{3} “Opinion” written on a web memorandum for making the friend relationship between the member A and the member B. Also, the evaluation information further can includes \textcircled{4} “Indifference”.

In another aspect of the present invention, an on-line social networking system based on third party's evaluation, the system comprising: a server of an Internet website for providing a social networking module; a first member terminal group being a member of the website, for requesting a friend relationship; a second member terminal group being a member of the website, for receiving a friend relationship request signal from the first member terminal group and determining whether to approve the friend relationship request; and a third member terminal group being a member of the website, for receiving information on an evaluation target member belonging to the first member terminal group from the second member terminal group and generating evaluation information on the evaluation target member.

Further, additional features and advantages are realized through the techniques of the present invention. Other embodiments and aspects of the invention are described in detail herein and are considered a part of the claimed invention.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIGS. 1 to 3 are views showing concepts of conventional online social networking methods;

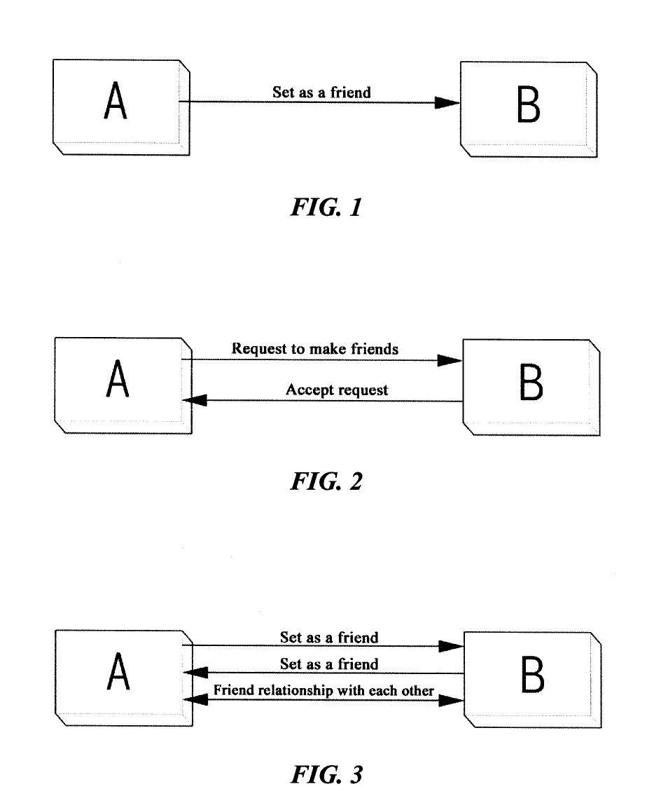

FIG. 4 is a view showing an evaluation group being a friend of a member who requests registration of a friend relationship according to one aspect of the invention;

FIG. 5 is a view showing an evaluation group being a friend of a member who has requested registration of a friend relationship according to another aspect of the invention;

FIG. 6 is a view showing an evaluation group being a shared friend of both a member who requests registration of a friend relationship and a member who has requested registration of the friend relationship according to still another aspect of the invention;

FIG. 7 is a combination of FIGS. 5 and 6, which shows existence of a list of shared friends;

FIG. 8 is a schematic view showing an example of a configuration of a webpage for requesting evaluation displayed on a monitor of a member who is requested registration of a friend relationship according to an aspect of the present invention;

FIG. 9 is a schematic view showing an example of a configuration of a webpage for monitoring a state of evaluation in real-time according to an aspect of the present invention;

FIG. 10 is a schematic view showing an example of a configuration of a webpage for performing evaluation displayed on a monitor of a group that receives an evaluation request according to an aspect of the present invention;

FIG. 11 is a schematic view showing an example of a configuration of a webpage displayed on a monitor of a member who requests registration of a friend relationship according to an aspect of the present invention; and

FIG. 12 is a flowchart illustrating an example of an outline process according to an aspect of the present invention.

### BEST MODE FOR CARRYING OUT THE INVENTION

Hereinafter, certain embodiments of the present invention will be described in detail with reference to the accompanying drawings. It is noted that details on the well-known components and their functions will not be described.

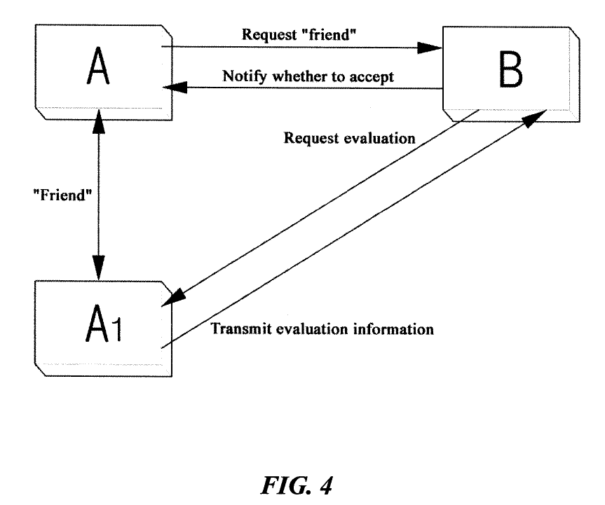

FIGS. 4 to 6 are schematic views showing the concept of an online social networking system according to an aspect of the present invention.

Users connect to the Internet using a terminal, such as a personal computer (PC), a notebook computer, or the like. Generally, communications among the users are accomplished through a website that provides services such as Internet communities, blogs, emails, and the like. In this case, the users have a status of a client, and the operator of the website becomes a server. Differently from such a server/client system, a network that horizontally connects terminals in a peer-to-peer method also exists. However, such a peer-to-peer system still needs a certain module in order to exchange information among peers and construct a community, and the module is generally provided by a server of a website that provides community services. Accordingly, users who participate in or desire to participate in an online-based human network join, as a member, a web tool provided for creating and maintaining the human network, i.e., join an Internet website that provide a social networking module.

Through community services provided by the Internet website, members take part in networking, and numerous communities are constructed. Each of the communities functions as an independent social network. However, members belonging to a community do not belong to only one community, but can be duplicatively belonged to a plurality of communities, thereby having a very complex friend relationship. In the present invention, such a complex friend relationship is largely categorized into three logical groups, i.e., an application group, evaluation group, and determination group, from the viewpoint of creating the friend relationship. The application group is a group of members who request creation of the friend relationship. The determination group is a group of members who become counterparts of the application group, which determines whether to create the friend relationship. The evaluation group is a group that evaluates an applicant of the application group and generates evaluation information in response to a request from the determination group, which has a very important status in the present invention. Since the determination group determines whether to create the friend relationship according to the third party's evaluation information, languages and behaviors on the web of the members belonging to the application group are affected by the evaluation group (since a request for a friend relationship can be repeatedly rejected if slanders are continued).

As shown in the embodiment of FIG. 4, in the present invention, a user being a target of creation of a friend relationship, i.e., a user belonging to the determination group, asks a third party belonging to the evaluation group for help to determine whether to create a friend relationship. If a member A terminal belonging to the application group requests a member B terminal belonging to the determination group to make a friend relationship, the member B terminal requests a member A₁ terminal, i.e., a third party, to generate evaluation information on whether making a friend relationship with member A is beneficial. This is a system where member A₁ generates evaluation information and provides the information to member B, and member B refers to the evaluation information and notifies whether to accept the request for making a friend relationship with member A. In the present embodiment, since member A₁ is already in a friend relationship with member A, member B can obtain further detailed information on member A and therefore reasonably determine whether making a friend relationship with member A is a good choice. However, since member A₁ is a friend of member A, objectivity of the evaluation information can be an issue. If the community where member B belongs to is completely different from the community where member A belongs to in human structure, education, culture, and the like, it is highly probable that member B cannot obtain desired evaluation information from member A₁ who is a friend of member A.

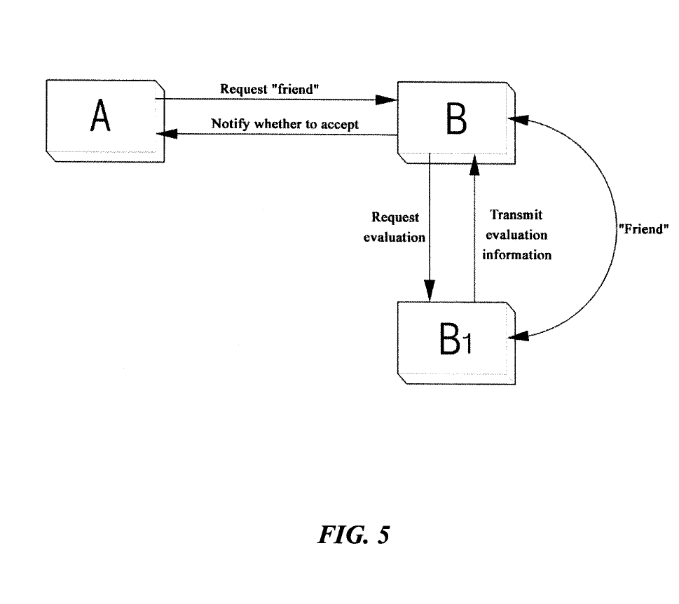

The embodiment of FIG. 5 is different from the embodiment of FIG. 4 in that third parties belonging to the evaluation group are not friends of member A, but friends of member B. If a member A terminal belonging to the application group requests a member B terminal belonging to the determination group to make a friend relationship, the member B terminal requests a member B₁ terminal, i.e., a third party, to generate evaluation information on whether making a friend relationship with member A is beneficial. This is a system where member B₁ generates evaluation information and provides the information to member B, and member B refers to the evaluation information and notifies whether to accept the request for making a friend relationship with member A. Member B₁ has an interest relation in making a friend relationship between member A and member B, since if member A makes friends with member B, member B₁ who already has a friend relationship with member B is involved in human networking with member A through member B. Accordingly, member B can obtain further objective evaluation information compared with the embodiment of FIG. 4, and it is advantageous in that opinions of members, who have been previously in a friend relationship with member B, on a new member who joins the networking can be understood. In this manner, member B can reasonably determine whether making a friend relationship with member A is beneficial. However, it is disadvantageous in that members belonging to the evaluation group are not quite acquainted with member A.

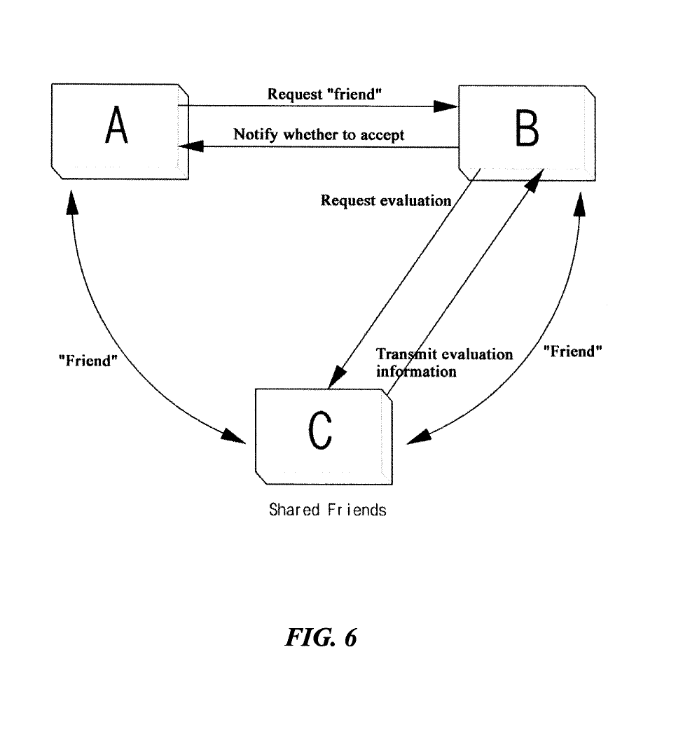

FIG. 6 is a view showing an embodiment in which disadvantages of the embodiments of FIGS. 4 and 5 are complemented. Members belonging to the evaluation group are friends of members A and also have a friend relationship with member B. Accordingly, the advantages of the embodiments of FIGS. 4 and 5 can be expected.

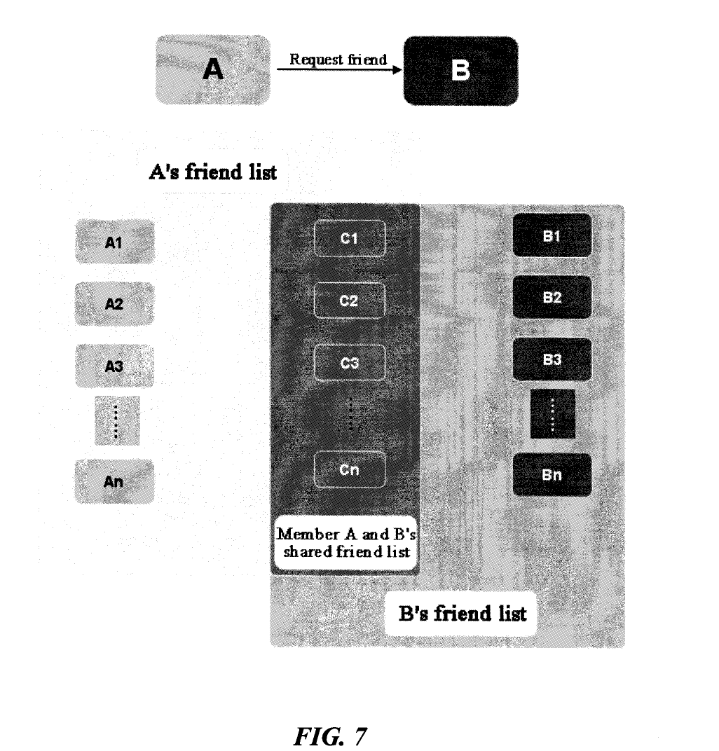

FIGS. 7 to 11 are views constructed on the assumption that the embodiments of FIGS. 5 and 6 are combined among a variety of embodiments of the present invention. That is, third parties who perform evaluation are categorized into friends of member B and shared friends of member A and member B. However, the present invention is not to be restricted by the embodiment depicted.

Referring to FIG. 7, a member A terminal requests a member B terminal to make a friend relationship. Member A and member B respectively have other members who have registered as having a friend relationship. For example, a friend list of member A shows “A₁, A₂, A₃, . . . , and Aₙ” (n is an integer not smaller than 1, which is the same hereinafter) and “C₁, C₂, C₃, . . . , and Cₙ”. Members “A₁, A₂, A₃, . . . , Aₙ” are not related to member B at all. However, members “C₁, C₂, C₃, . . . , and Cₙ” also have a friend relationship with member B. That is, members “B₁, B₂, B₃, . . . , and Bₙ” who are not related to member A are in a friend list of member B, together with members “C₁, C₂, C₃, . . . , and Cₙ” who are friends of member A. In the present invention, member B who is requested to make a friend relationship requests two groups, existing members who have a friend relationship with member B and members who have a friend relationship with both member A and member B, to generate evaluation information on member A.

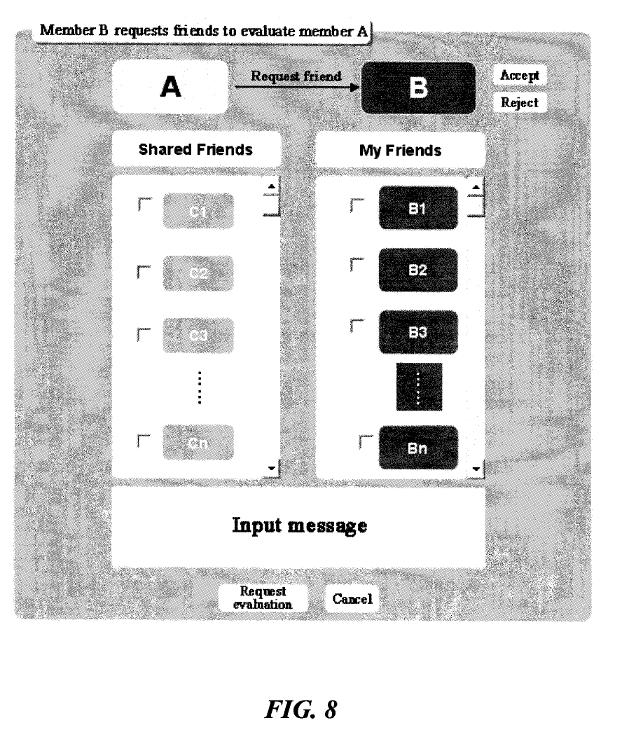

FIG. 8 is a view showing an example of a screen configuration of a webpage (that can be pop up as a frame of a small size, which is the same hereinafter) displayed when a member B terminal that is requested to make a friend relationship requests evaluation information on a member A terminal. The member B terminal can instantly ‘accept’ or ‘reject’ the request of member A suggesting to make a friend relationship. However, as shown in the figure, the web server, through the social networking module, shows member B two evaluation group lists, i.e., a list of members who have a shared friend relationship with both member A and member B, and a list of members who are currently registered as a friend of member B. Member B can arbitrarily select members among the members in the lists and request an evaluation on member A. If member B requests the selected friends to evaluate member A, details of the request are transmitted to the friends in the form of a message.

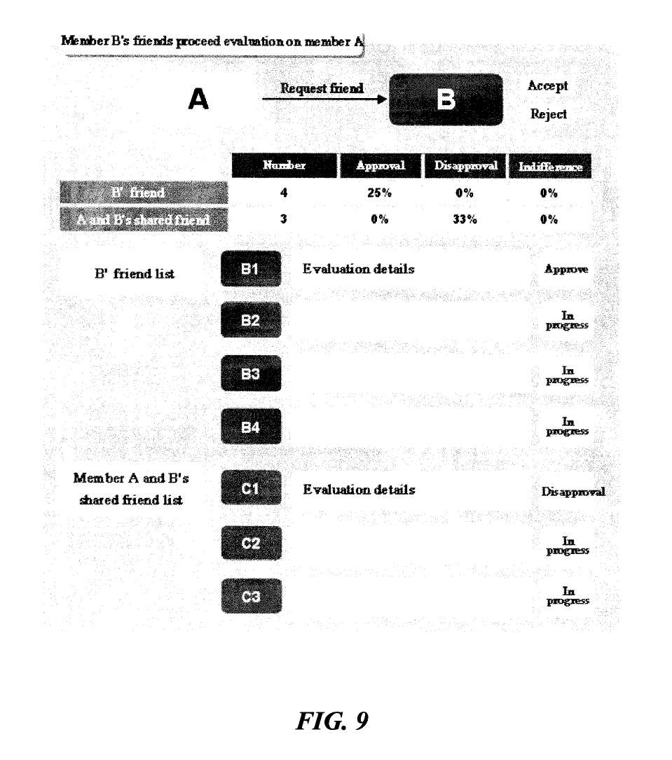

FIG. 9 is a view showing an example of a screen configuration of a webpage displayed on the monitor of member B, when the member B terminal transmits a request of evaluation on member A according to FIG. 8. The screen shows a list of members who participate in the evaluation, and if member B clicks a name or a thumbnail from the list, the screen moves to a detailed screen (showing a profile, detailed information, and the like) of a corresponding member. If the selected members Bₙ or Cₙ complete generating evaluation information, details of the evaluation are shown on the screen of member B in real-time, together with a table containing information related to an evaluation state, such as the number of members participating in the evaluation, approval rate, disapproval rate, and the like. As a matter of course, member B can cancel the evaluation even when not all of the members belonging to the evaluation group complete the evaluation. If the evaluation is cancelled, percentages in a result will be shown with values calculated at the time of calculation.

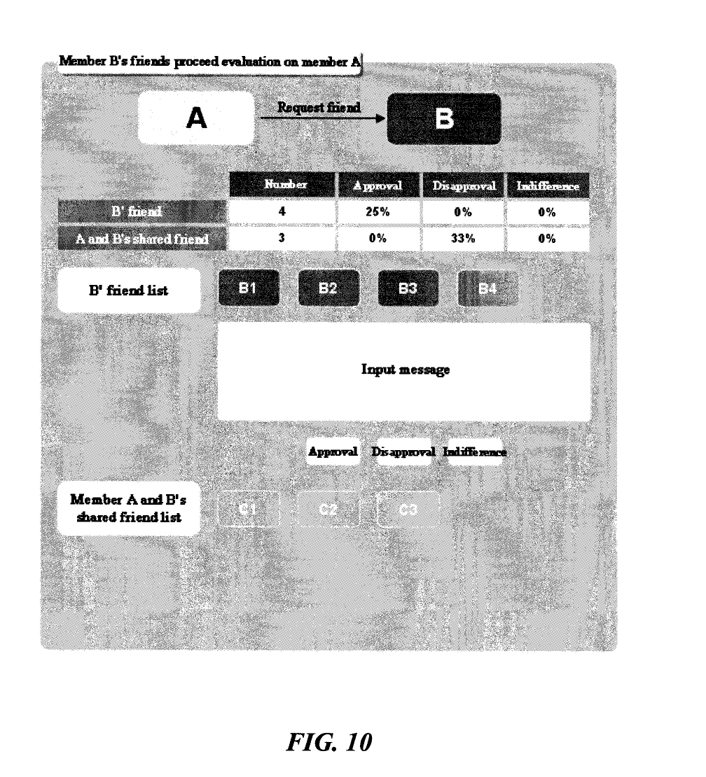

FIG. 10 is a view showing an example of a screen configuration of a webpage displayed on the monitors of members who are requested to evaluate. A member who receives an evaluation request can confirm details of the request through a message. As shown in FIG. 10, the web page of a friend member who receives the evaluation request includes a table showing a current evaluation state, a list of members who take part in the evaluation, and evaluation information generating means, in which means for inputting opinions, buttons for selecting ‘Approval’, ‘Disapproval’, and ‘Indifference’, and the like are provided as the evaluation information generating means.

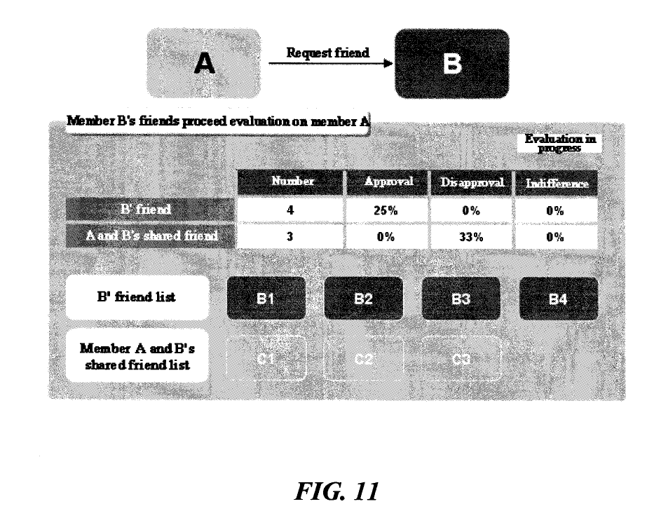

FIG. 11 is a view showing an example of a screen configuration of a webpage displayed on the monitor of the member A terminal that has requested making a friend relationship. Basic configuration thereof is similar to the configuration of the webpage of the evaluation group shown in FIG. 10. However, the screen does not have a function of actively inputting messages contrarily to the screen shown in FIG. 10. Through this webpage, member A can understand how the friends of member B evaluate member A, and how the shared friends of member A and member B evaluate member A. Such a function makes members be mindful of third party's evaluation when doing online activities in the same way as doing offline networking.

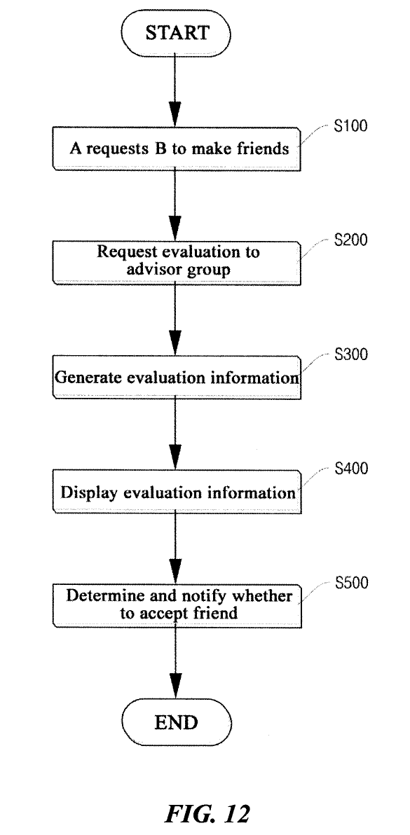

FIG. 12 is a flowchart illustrating an example of an outline process of an online social networking method based on third party's evaluation according to the present invention. A member A terminal desires to be a friend of another member B terminal. Accordingly, the member A terminal transmits a friend relationship registration request signal to the member B terminal S100. The member B terminal that receives the friend relationship registration request signal opens an evaluation request webpage by executing the social networking module, selects one or more terminals among terminals belonging to an advisor group, and requests evaluation on member A S200. A terminal of the advisor group that receives the evaluation request signal opens a webpage for evaluators by executing the social networking module and generates evaluation information on member A S300. The evaluation information issues an event, such as “Approval”, “Disapproval”, and “Indifference”, and the like, and can include a text document for suggesting an opinion.

As described above, the advisor group can be selected by appropriately combining one or more of \textcircled{1} a group of member A's friends, \textcircled{2} a group of member B's friends, \textcircled{3} a group of friends having a shared friend relationship with both member A and member B. In the preferred embodiment, the social networking module sets friends belonging to the friend group \textcircled{2} and \textcircled{3} as the advisor group. Accordingly, member B who receives the friend relationship registration request signal selects one or more members among the members belonging to the group \textcircled{1} and \textcircled{2}.

The member B terminal opens a monitoring webpage in real-time, monitors a current evaluation state in real-time as shown in FIG. 9 S400, and transmits a response signal notifying whether to accept the friend relationship registration to the member A terminal referring to the evaluation information monitored in real-time S500. If the response signal is “Yes”, the server registers the fact that member A is in a friend relationship with member B into a database, and accordingly, information on member A and member B is updated.

According to the present invention described above, third parties' opinions can be listened and integrated in building online human networking.

In the present invention, when a new friend relationship is established among members in an online space, a member who desires to make a friend relationship is allowed to refer to evaluation of a nearest third party, and thus it is effective in that further stable networking is established.

Through the configuration of the present invention, since a network of only those users who can trust in one another is guaranteed, it is advantageous in that quality of human structure in the network is enhanced and a variety incidents prevailed in the Internet is prevented.

Such unique effects of the present invention can make negative influences of online social networking be overcome and further practically contribute to developing online-based networking or communities.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An on-line social networking method based on third party's evaluation, where terminals are connected to one another through the Internet, the method comprising:
allowing a certain member (member A) terminal to transmit a friend relationship registration request signal to another member (member B) terminal;
allowing the member B terminal to transmit an evaluation request signal for evaluating the member A to one or more terminals belonging to an advisor group;
allowing a terminal of the advisor group that receives the evaluation request signal to generate evaluation information on the member A;
allowing the member B terminal to monitor the evaluation information in real-time;
allowing the member B terminal to transmit a response signal notifying whether to accept the friend relationship registration to the member A terminal; and
if the response signal is “Yes”, registering a fact that the member A and the member B have a friend relationship with each other.

2. The method according to claim 1, wherein the advisor group is a member group (A₁, A₂, A₃, . . . , and Aₙ, n is an integer not smaller than 1) having a friend relationship with the member A.

3. The method according to claim 1, wherein the advisor group is a member group (B₁, B₂, B₃, . . . , and Bₙ, n is an integer not smaller than 1) having a friend relationship with the member B.

4. The method according to claim 1, wherein the advisor group is a member group (C₁, C₂, C₃, . . . , and Cₙ, n is an integer not smaller than 1) having a friend relationship with both the member A and the member B.

5. The method according to claim 1, wherein the advisor group includes a first group (B₁, B₂, B₃, . . . , and Bₙ, n is an integer not smaller than 1) having a friend relationship with the member B and a second group (C₁, C₂, C₃, . . . , and Cₙ, n is an integer not smaller than 1) having a friend relationship with both the member A and the member B.

6. The method according to claim 1, wherein the members are members of a same website that provides a social networking module.

7. The method according to claim 1, further comprising the step of:
allowing the member A terminal to monitor the evaluation information in real-time.

8. The method according to claim 1, wherein the evaluation information includes \textcircled{1} “Approval”, \textcircled{2} “Disapproval”, and \textcircled{3} “Opinion” written on a web memorandum for making the friend relationship between the member A and the member B.

9. The method according to claim 8, wherein the evaluation information further includes \textcircled{4} “Indifference”.

10. An on-line social networking system based on third party's evaluation, the system comprising:
a server of an Internet website for providing a social networking module;
a first member terminal group being a member of the website, for requesting a friend relationship;
a second member terminal group being a member of the website, for receiving a friend relationship request signal from the first member terminal group and determining whether to approve the friend relationship request; and
a third member terminal group being a member of the website, for receiving information on an evaluation target member belonging to the first member terminal group from the second member terminal group and generating evaluation information on the evaluation target member.
